(19) United States
(12) Patent Application Publication
(10) Pub. No.: US 2006/0007945 A1
(43) Pub. Date: Jan. 12, 2006

(54) Medium to disparate medium hopping mesh network

(76) Inventors: Roland Schoettle, Glen Cove, CA (US); Peter El Kwan Chow, Orlando, FL (US); Soorya Kuloor, Calgary (CA)

Correspondence Address: DALLAS OFFICE OF FULBRIGHT & JAWORSKI L.L.P., 2200 ROSS AVENUE, SUITE 2800, DALLAS, TX, 75201-2784, US

(21) Appl. No.: 11/172,392

(22) Filed: Jun. 30, 2005

Related U.S. Application Data
(63) Continuation-in-part of application No. 10/094,743, filed on Mar. 11, 2002.
(60) Provisional application No. 60/585,557, filed on Jul. 2, 2004.
(60) Provisional application No. 60/591,265, filed on Jul. 26, 2004.

(51) Int. Cl. H04L 12/28

(52) U.S. Cl. 370/401

(57) ABSTRACT

A hopping mesh network is described that employs two or more disparate media to connect multiple intelligent devices into a network capable of passing high-speed data. Each intelligent device is able to select the most appropriate media based on the data to be used to transmit the media, and may switch data between disparate media as necessary during the transmission of the data. Each media is configured to contain multiple channels which are also used by the intelligent devices to transmit data on the network. A generic, protocol-neutral wrapper can also be used in the hopping mesh network to allow transmission of multiple protocols without the need for conversion between protocols.

### CROSS-REFERENCE TO RELATED APPLICATIONS

This application claims priority benefit of U.S. Provisional Patent Application No. 60/585,557 entitled “SYSTEM AND METHOD FOR MANAGING POWER END-USER DISTRIBUTION,” filed Jul. 2, 2004; U.S. Provisional Patent Application No. 60/591,265 entitled “SYSTEM AND METHOD FOR MANAGING POWER END-USER DISTRIBUTION,” filed Jul. 26, 2004; U.S. patent application Ser. No. ______ [Attorney Docket No. 66816-P002U.S. Pat. No. 1,040,6650] entitled SYSTEM AND METHOD FOR MANAGING END-USER POWER DISTRIBUTION, filed concurrently herewith; and U.S. patent application Ser. No. 10/094,743 entitled HYBRID FIBER/CONDUCTOR INTEGRATED COMMUNICATION NETWORKS, filed Mar. 11, 2002, the disclosures of which are hereby incorporated herein by reference.

### TECHNICAL FIELD

The concepts described herein relate to hybrid network architectures which pass data between disparate media such as wire line, wireless, and fiber.

### BACKGROUND OF THE INVENTION

Very large networks, including communication networks and power delivery networks, suffer from a variety of limitations, including the ability to have visibility into what is occurring at the delivery points, or ends of the networks, and the ability to pass high-speed data at the delivery points or ends of those network. Providers have developed very efficient cores into which those network providers have engineered very good visibility and control mechanisms. Providers are informed very quickly of problems within their network, such as a malfunctioning switch or blown transformer, and can very quickly take steps to re-engineer the network to overcome these problems.

As stated, however, providers have very limited, or no, visibility into what is occurring at the very ends of the networks, or the delivery points, where the consumers use the actual resources. These points can be homes, neighborhoods, apartment or office buildings, or other types of power or communication network end points. Some reasons for this lack of visibility are, among others, existing infrastructure at these end points is usually simple and dumb, and structures like office or apartment buildings can contain literally miles and miles of wiring. The existing infrastructure, such as copper wires, switches, transformers and power outlets in power networks, and twisted pair wires, cat 5 cables, etc. in communications and data networks, is very efficient in providing the services, but provides very little information back to the provider as to what is actually occurring at the user end points in the network.

Providing intelligence into these networks has been a difficult task. Attempts to use the existing infrastructure, such as using the power lines to carry data inside buildings, have run into problems. Power lines are inherently very noisy and lossy, making the passing of the high-speed data required to pass the amounts of information required impossible. Further, in office buildings a floor, or group of floors, usually have their own transformers which isolate the power lines for that floor, or group of floors. The transformers act as barriers to the passing of high-speed information. The physical structures of buildings make using wireless networks difficult or impossible. The metal used in the buildings prevents the wireless signals from propagating for any significant distance. The only reliable method for providing intelligence into the networks requires running additional wiring in parallel with the existing networks to connect sensors, processors and other devices in an attempt to provide visibility into the networks.

These same problems of infrastructure prevent the delivery of high-speed data such as HDTV, cable services, etc. without having to retrofit the buildings with structured wiring to carry these services. In existing buildings this can be a daunting and expensive proposition because of the miles of wiring involved and the cost to physically run the structured wiring necessary to provide the visibility, intelligence, and capability to deliver high-speed data.

### BRIEF SUMMARY OF THE INVENTION

The concepts described herein describe a hybrid network, or a hopping mesh network, that uses existing infrastructure in network end points, such as office buildings, to pass high-speed data traffic which allows visibility, intelligence and high-speed data delivery using, in part, the existing infrastructure of a building. An embodiment of the network uses intelligent devices connected to two or more disparate media to pass data through the network. The intelligent devices can select the most appropriate media for the destination of the data, and can switch data between media to utilize the most efficient and appropriate media for the data being passed. Disparate media may also be used in an embodiment to bridge gaps between networks that cannot be easily connected with the media used in those networks.

In another embodiment, each of the disparate media used in the network is configured to carry two or more channels of information. Each intelligent device can select not only between media, but also between channels within the media. The channelization of the media can be used to overcome noise and loss issues associated with the particular media.

In another embodiment, data passing over the hopping mesh network is packetized and encapsulated into a generic, or protocol neutral wrapper. The generic wrapper allows the network to pass data packets in the network without regard to the particular protocol format of the packet. This simplifies the operation of the network as each of the disparate media used in the network might produce packets using a particular protocol or set of protocols which would require conversion for transmission on a disparate media. By employing the generic, protocol neutral wrapper, the network can pass any type of data packet across the hopping mesh network and remove the wrapper before the packet is sent on an external network.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a simplified block diagram showing an embodiment of a hopping mesh network in accordance with the concepts described herein;

FIG. 2 is a simplified block diagram showing an embodiment of a heterogeneous transport and a multi-media transport for use in a hopping mesh network in accordance with the concepts described herein;

FIG. 3 is a simplified block diagram showing an embodiment of a multi-function transport for use in a hopping mesh network in accordance with the concepts described herein;

FIG. 4 is a simplified block diagram showing an embodiment of the LCU shown in FIG. 1;

FIG. 5 is a simplified block diagram of showing an embodiment of an intelligent device or “modbot” from FIG. 1;

FIG. 6A is a diagram illustrating an embodiment of a generic, protocol-neutral packet wrapper for use in a hopping mesh network in accordance with the concepts described herein; and

FIG. 6B is a simplified block diagram of illustrating the operation of the generic packet wrapper of FIG. 6A.

### DETAILED DESCRIPTION OF THE INVENTION

The concepts described herein are directed to a system and method for allowing the existing infrastructure of a building or other end point network to be quickly structured into self-creating, self-sustaining, fully integrated, fault-tolerant, redundant, cross-media, protocol neutral, hopping mesh, or hybrid, broadband, megaband, or ultra-wideband data network for providing and maintaining high-performance communications, monitoring and device operation and control within, throughout, between and among one or more buildings or other end point network, which is capable of connecting directly to and communicating directly and securely with large guided media digital data communications systems (including power line, coaxial cable, fiber optic, Ethernet, DSL and varieties of DSL and other twisted pair media, and FireWire), at neighborhood data distribution terminals.

An embodiment of the system and method according to the concepts described herein, is capable of unifying disparate proprietary systems, devices and appliances into a single user operated, controlled and monitored network comprised of multiple diverse devices and appliances using a variety of intelligent devices, which may be either physical devices, logical devices, chips, or chip sets. Each intelligent device is, automatically self-configuring, and interconnecting, consumes low-power and is capable of wired, wireless, powerline, fiber, and other forms of bi-directional high-speed communications. An embodiment of the system and method also includes a gateway device that communicates with the other hardware devices into building electric power systems, into other building systems, and into building appliances.

An embodiment of the system and method uses both wireless and guided media to communicate between and among the hardware devices, the gateways, the systems and the appliances to which the hardware devices have been connected throughout, between and among buildings. The embodiment of the system and method determines which of the media to use for communications on an ad-hoc, opportunistic, as needed and as available basis. Allowing the intelligent hardware devices to determine which media is most appropriate to use creates a hybrid mesh network in which the data hops between media as it is passed from hardware device to hardware device and to gateways.

An embodiment of the system and method further describes linking the hardware devices, gateways, systems and appliances using a generic, protocol neutral, communications system, in which the existing protocol dependent communications are encapsulated in a generic wrapper according to the concepts described herein. Using the generic wrapper for communications within the system allows data to be passed between channels and media without having to perform protocol conversions that would otherwise be necessary. This also allows the hardware to automatically self-configure, interconnect and securely communicate among themselves and with other systems, devices and appliances over any media.

A further embodiment of the system and method describes a mechanism for providing users of the hopping mesh network the ability to monitor, analyze and control the network and any or all systems, devices and appliances within the network through a system of hardware monitors and control devices employing integrated software from within the network or from outside the network.

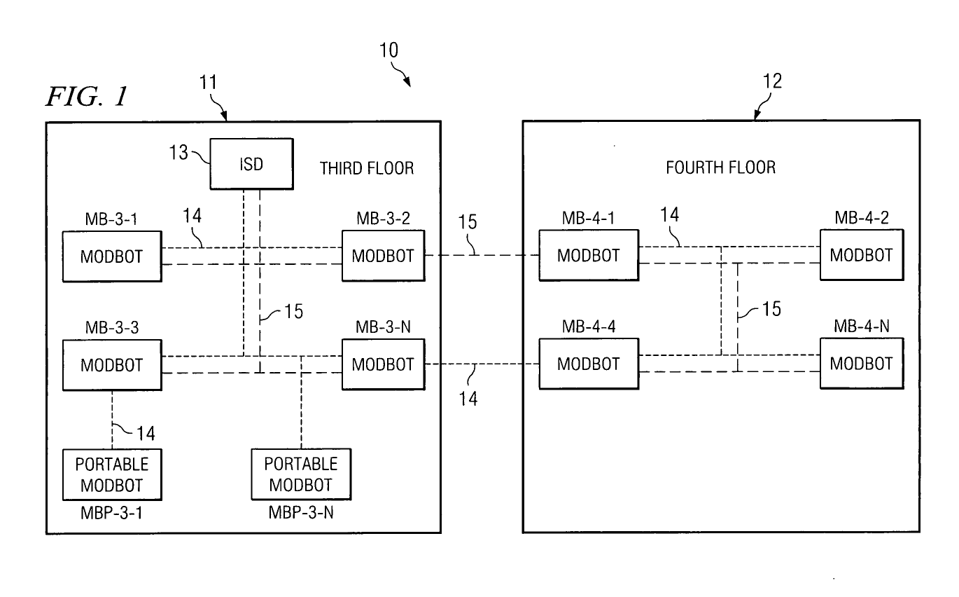

FIG. 1 shows one embodiment of a hopping mesh network 10 in accordance with the concepts described herein. In the example of FIG. 1, network 10 is shown operating both within and across floors 11 and 12. On floor 11, multiple intelligent devices, which can be modular robots (“modbots”) MB-3-1 to MB-3-N are interconnected using both a hardwired (wireline) network 15 and a wireless network 14. Portable modbots MBP-3-1 to MBP-3-N are also interconnected using only the wireless network 14, portable modbot MBP-3-1 is connected to the network through modbot MB-3-3.

Also interconnected in the network using both wireless 14 and wireline network 15 is a local control unit (“LCU”) 13, which can be an intelligent serviced director (“ISD”). LCU 13 would be the central gateway for communication between and among the intelligent devices connected to it and the intelligent devices connected to other LCUs as well as for communication to outside networks. LCU 13 is also operable for assembling and maintaining a digital copy of that premise's environment. There could be several levels of intermediate distribution points serving a particular building or a single LCU connecting to a central control or intermediate distribution point.

The LCU communicates with the intelligent devices, for example, by using redundant power line communications and/or 900 megahertz ISM band RF communications, etc. The modbots which can be plug and play in one embodiment, produce a mesh network that allows information to hop and skip between and among modbots and the LCU to which it can communicate, either directly or indirectly. Likewise the LCU can use the modbots to hop and skip to find any specific modbot in the network. This is done in cases where a particular communications approach based on a single communications medium or a simple combination of multiple mediums (e.g., where both RF and power line communications do not reach a particular modbot directly). A combination of two or more modbots can be used to communicate with a specific modbot, if required.

For example, the intelligent devices, modbots MB-4-1 to MB-4-N on floor 12 are connected to LCU 13 though modbots MB-3-2 and MB-3-N. Specifically, in the example shown, modbot MB-4-1 is connected to LCU 13 using modbot MB-3-2 over wireline network 15 while modbot MB-4-4 is connected to LCU 13 through modbot MB-3-N over wireless network 14. All the intelligent devices, or modbots, on floor 12 are interconnected to each other over both the wireline network 15 and the wireless network 14.

As an example of the functionality of the system, in an embodiment this system can be used to provide high-speed data access such as an intranet or Internet connection. Within the building, the LCU can, if desired, provide high speed Internet access if the premise does not already have such. The LCU can also provide many other features and services.

While wireline network 15 can employ any type of physical network transmission lines or other guided media, one embodiment uses the power lines to provide the physical interconnection between and among devices.

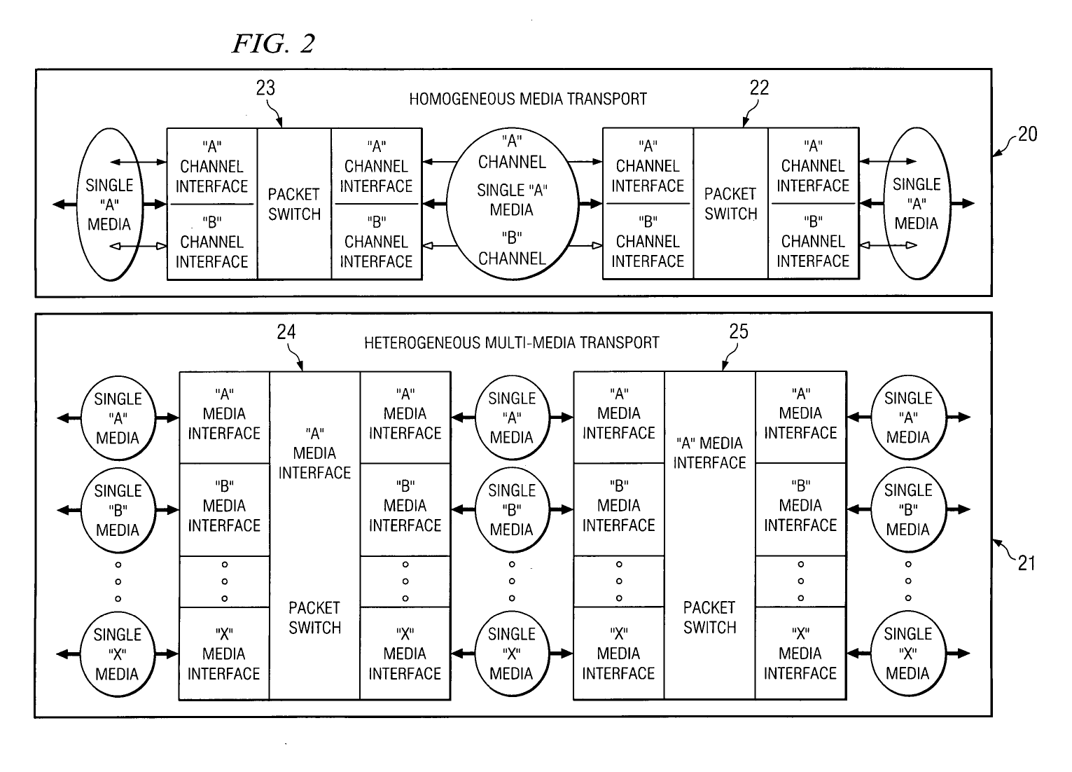

Referring now to FIG. 2, embodiments of methods and mechanisms for passing data between the intelligent devices of FIG. 1 are described. Homogeneous media transport 20 shows the use of channels within a single media, whether the media be wireline, powerline, wireless or other media. Packetized data to be sent on the media is modulated and placed in one of a plurality of available channels, shown as A channel and B channel in the example of homogeneous media transport 20. When the packetized data is received over a channel at an intelligent device or modbot, a transport layer, shown as transport layer 22 or 23, within the modbot receives the packetized data on either the A channel or the B channel. The packetized data is passed through a channel interface which is operable to modulate and demodulate the channels to place and remove the packetized data on the appropriate channel. Next the packetized data passes through a packet switch which selects the appropriate channel for retransmission and may include a packet pump to ensure that the signal strength of the signal carrying the packetized data is at the appropriate level. The packetized data is then sent through the outbound channel interface. The channel interface on the outbound side, the outbound side depending on the direction the data is traveling, then operates to place the data onto a channel which may be different than the channel the data was received on. In the example of homogeneous media transport 20, data received on the A channel can be retransmitted on the B channel and vice versa.

The purpose of the channel switching described above is designed to compensate for the noise and loss associated with the transmission medium. Powerlines, in particular, are very noisy and very lossy for high-speed data transmission and can only maintain signal strength over short distances. By having intelligent devices with transport layers, as described, at relatively short intervals, and by employing the channel switching, data can be effectively transmitted at very high speeds along any media in hybrid network 10 from FIG. 1. As an example, under normal conditions a particular media may be able to transmit a signal a distance X before the signal loses enough of its signal strength to be unusable due to the noise and loss of the media. While equipment may be used at intervals to boost the signal this equipment is expensive and complicated. Using the transport mechanism of homogeneous transport 20 contained in simple inexpensive devices placed in the path of the signal, however, would allow the signal to be transmitted indefinitely as the signal strength is restored every time the signal is switched from channel A to channel B. While this configuration does halve the bandwidth for the media, where two channels are employed, it allows noisy and lossy media, that would otherwise be unsuitable, to be used for transmission of high-speed data.

While the embodiment of homogeneous media transport 20 shown in FIG. 2 describes a mechanism to overcome noise and loss within a single media in hybrid network 10, homogeneous media transport 20 does not address switching between disparate media within the network, such as, for example, between powerline and wireless.

An embodiment of a multi-media transport is described with respect to heterogeneous multi-media transport 21. Heterogeneous multi-media transport 21 provides a mechanism for passing data across disparate media. While multi-media transport 21 shows two media, A media and B media, any number of different media could be accommodated. Multi-media transport layer 24 and 25 operate in the same manner as transport layers 22 and 23, except that the channel interface has been replaced with a media interface. Instead of choosing a channel on a modulated carrier, the media interface places the data on the appropriate media, as determined by the packet switch, for the destination of the packetized data.

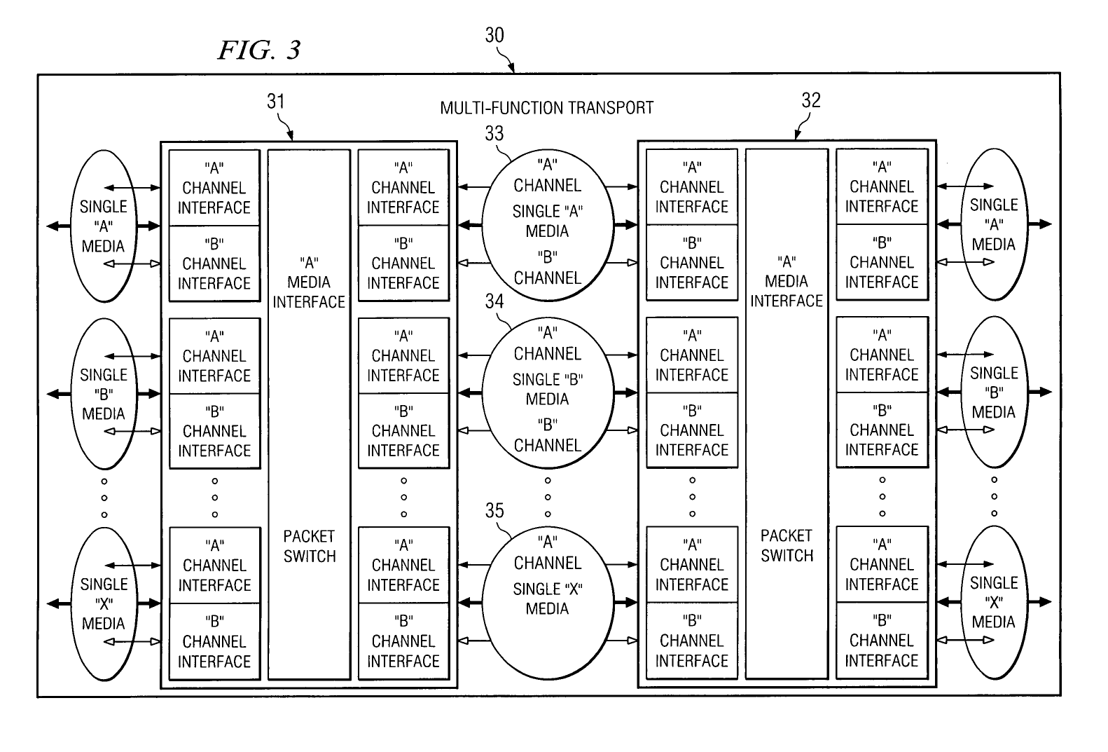

Referring now to FIG. 3, an embodiment of a transport mechanism combining the homogeneous transport 20 and multi-media transport 21 of FIG. 2 is shown. Multi-function transport 30 is formed by the transport layers in individual intelligent devices, such as is shown by transport layers 31 and 32. Each transport layer, such as transport layers 31 and 32, is operable to receive transmissions on one or more media types. Transport layers 31 and 32 are shown as receiving transmissions on media 33 and 34. Multi-function transport 30 is expandable to include additional media types such as media 35. Within each media, the packetized data is placed on one of two or more channels transported over the media, as was described with reference to homogeneous media transport 20 from FIG. 2.

Each transport layer in multi-function transport 30 includes both channel interfaces for channelizing the packetized data within a particular media, and also packet switches for selecting between available media types within the hopping mesh network. Once data is received, it is taken from its particular channel, passed through the channel interface and packet switch to place it on the desired media, and then rechannelized to a channel within that media type. Again, while a specific number of media types and channels per media are shown in FIG. 3, any number of channels and media types can be incorporated into the transport layers of the intelligent devices without departing from the scope of the concepts described herein.

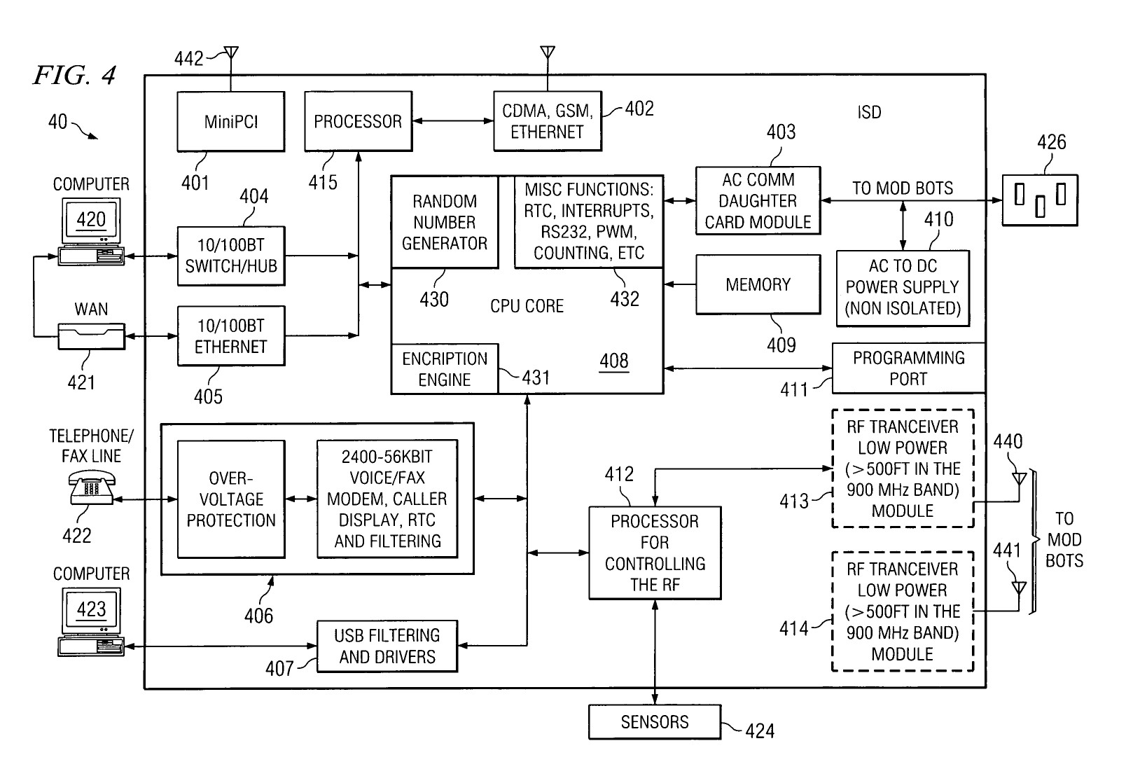

FIG. 4 shows one embodiment 40 of a local control system, (LCU) such as system 40-1 which, as discussed above, provides a digital copy of the premise covered by system 40-1 to central control via one or more intermediate distribution points. The LCU has several PCI connectors (such as connectors 401) that are used for any number of PCI cards that are available as plug-in expansions for functionality to the LCU, for example, via antenna 442. One such example of this communication would be the 802.11 standard for communicating with local distribution point which acts as an aggregation point for multiple LCUs. Another example would be a voice over IP usable with a local LAN or WAN (element 421) network (elements 404 and 405) or with a USB port (element 407) to a computer(s) such as computer 420 or computer 423. Other circuits provide various other modes of communication, such as fax and/or telephone for backup communications in the event of a failure of a data connection. If desired, a camera can be connected. Also, if desired, a RJ45 (or other type) module can be provided to allow legacy connections to other equipment.

It should be understood that the LCU can stand alone without communication to or from any other LCU, or LCU 40-1 can, if desired, communicate directly with one or more other LCUs.

Processor 412 provides control for RF transceivers 413 and 414 to and from the modbots, as well as handling sensors (such as third party sensors). Transceivers 413 and 414 are, for example, 900 megahertz ISM transceivers. One can be used for regular communications and the other can be placed into receive mode for emergency communications if a modbot or other device needs to communicate with the LCU immediately. Memory 409 consists of both volatile and non-volatile memory and holds the data, settings and applications for controlling the LCU in cooperation with control 408 and/or processors 415 and 412.

The LCU can be upgraded via its wide area connections, or via port 411, if a program upgrade exists, and it receives this from either the local distribution point or the intermediate distribution point or from a user. Power is supplied via power supply 410, and AC power line communications for connection to the modbot within the premise is controlled by circuit 403. CDMA or GSM module 402 is used for wide area connections or other connections as necessary. Processor 415 provides communications control to assist CPU 408. This function could, if desired, be handled by processor 408 or by a processor internal to each communication device. CPU 408 is the main processor to the system and includes random number generator 430, encryption engine 431 and other multiple functions 432. This processor, in one embodiment, handles communications throughout all devices, including interrupts, as necessary, and all programming.

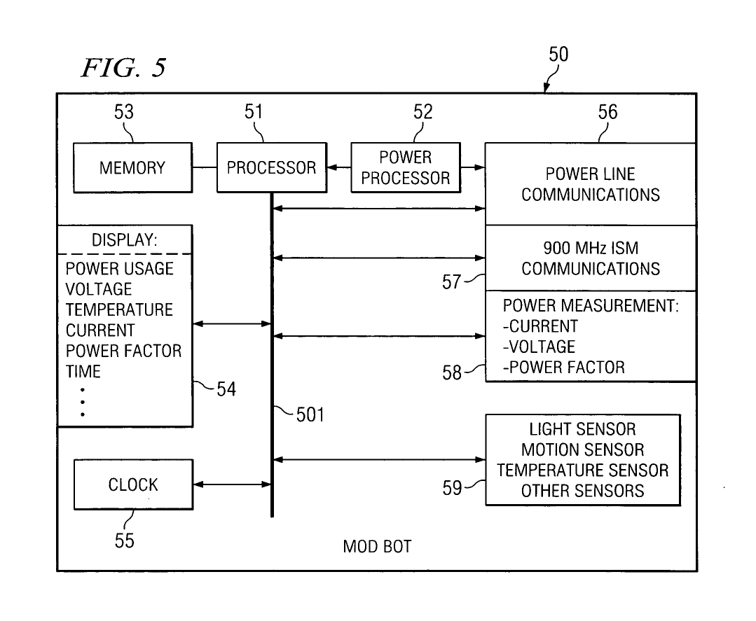

FIG. 5 shows one embodiment 50 of an individual control element, such as plug-in modbot. Inside modbot 50 is main processor 51, as well as, memory 53 and power processor 52. Modbot 50 can be remotely upgraded with a program upgrade via an LCU (FIGS. 1 and 4) which in turn receives its information from an intermediate distribution point. Display 54 displays the necessary vital information to the user of the device in visual format. Thus, a user can “see” a unified whole and can take any desired action. This information includes clock 45, as well as many other displays. Power line communication is controlled by circuit 56, (which communicates with element 426, or an equivalent thereof, FIG. 4) while 900 megahertz transceiver 47 also communicates with the LCU via elements 413 and 414, FIG. 4. Power measurements are controlled by circuit 58 and these include electrical parameters, such as power usage, current, voltage, impedance, and power factor. In addition to the multiple media connections, shown by example in modbot 50 to be powerline communications and 900 MHz wireless communications, though any type media may be accommodated, sensors may be contained within the modbot as shown by element 59.

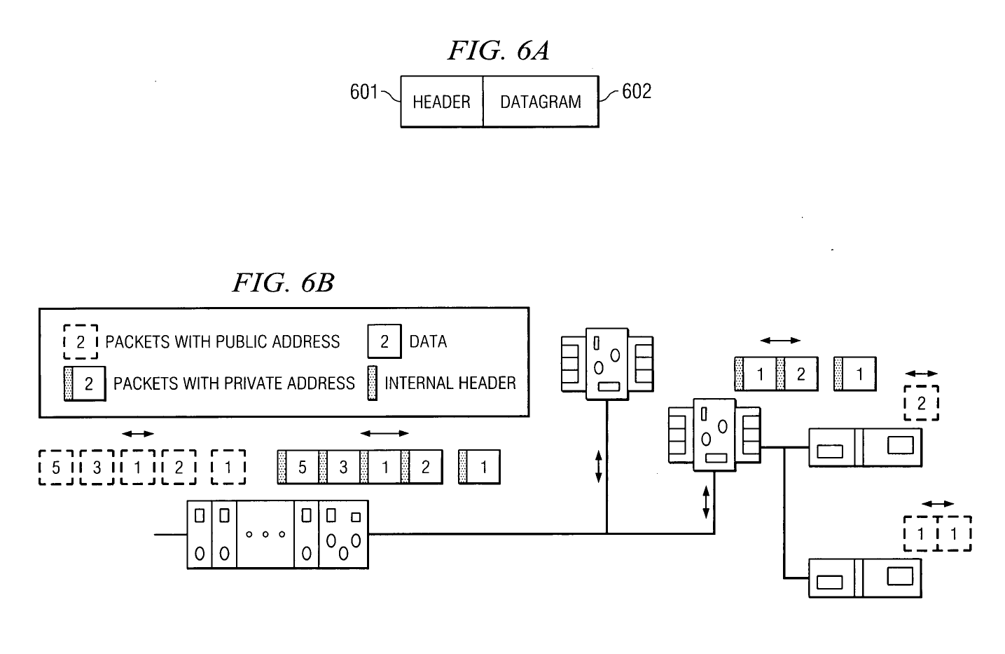

Referring now to FIGS. 6A and 6B, each modbot and LCU can be configured to have a unique internal or private address on the embodiment of hopping mesh network shown in FIG. 1. Such internal addresses of the embodiment are assigned automatically during an initialization process and the internal address design preferably includes addresses for packets that are designated for modbots and LCUs. The internal addresses may be used in a generic, or protocol-neutral header to encapsulate a datagram, e.g., a packet in an external network native format, as shown as datagram 602 in FIG. 6A. The encapsulation header, header 601 used to form the generic wrapper illustrated by FIG. 6A, preferably consists of modbot and/or LCU addresses with FEC and ideal bytes. The purpose of the embodiment ideal bytes are to allow hardware to determine the datagram without buffering the datagram, thereby facilitating the use of simplified modbots.

It should be appreciated that the LCU of the embodiment can be shared among many users and, therefore, presents less of a cost sensitivity than some other network devices. Moreover, it should be appreciated that the modbot hubs of the preferred embodiment are deployed in relatively large numbers leading to greater cost sensitivity. Accordingly, the embodiment of the present invention utilizes the generic wrapper and/or private addressing scheme described to allow simplification of the modbots. Specifically, using generic wrapper and private addresses assigned to various network devices, the modbots may be deployed to provide the requisite level of packet routing/switching in a hardware implementation. Such an implementation presents a relatively simple and highly reliable configuration, in addition to reducing the latencies associated with transmission of a data packet as compared to the use of typical software routing/switching techniques. Accordingly, the preferred embodiment configuration using generic wrapper and private addressing as described above allows for the more complex operations, and therefore modules, to be disposed in the LCUs and modbots, while allowing a relatively simple modbot configuration to be used. This preferred embodiment provides a network link between such LCUs and/or modbots which is substantially passive.

The generic wrapper architecture of the hopping mesh network can be similar to the Ethernet or IP packet-based architecture, except that the LCU of this embodiment preferably encapsulates the packet with an equipment identification number or other unique header in front of each packet, as shown in FIG. 6A. Accordingly, the modbots and LCUs can preferably select the right packet based on the user destination routing header in real time, as illustrated in FIG. 6B. In other words, there is no long buffer involved as is typically the case with IP switching.

The internal address information is preferably stripped from the packets by an edge device located on the edge of the hopping mesh network. The edge device can be an LCU or other network device which communicates between the hopping mesh network and an external network. The edge device can thereby provide a packet in its native form at the external interface. Accordingly, an embodiment of the invention presents a communication network which is transparent to external systems coupled thereto. By providing a standardized interface protocol at the edge devices and/or LCUs, systems coupled thereto may utilize commonly available data communication interfaces without requiring special adaptation for communication via the embodiment hopping mesh network system. Of course, it should be appreciated that the present invention is not restricted to use of a same interface protocol at all external interfaces thereof. For example, the edge devices and/or LCUs may provide arbitration between various interfaces, such as Gbit Ethernet, 100 Mbit Ethernet, 10 Mbit Ethernet, SONET, ATM, and the like, to thereby facilitate bridging of communications between systems using different communication protocols.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A network comprising:
a first media used to pass data;
a second media used to pass data; and
at least two intelligent devices connected to both the first media and the second media, each of the at least two intelligent devices including a transport layer operable to switch data between the first and second media repeatedly as necessary to transmit the data.

2. The network of claim 1 wherein the first media is comprised of powerlines in a building.

3. The network of claim 1 wherein the second medial is a wireless media.

4. The network of claim 1 wherein each of the first and second media include two channels for transmitting the data.

5. The network of claim 1 wherein the data is encapsulated in a protocol-neutral wrapper for transmission on the network.

6. The network of claim 5 further comprising an edge device connected between the network and an external network, the edge device operable to remove the wrapper from the data before sending it on the external network.

7. The network of claim 1 further comprising a third media connected to the at least two intelligent devices.

8. The network of claim 1 wherein the network is formed in part using existing infrastructure in a building.

9. A method of passing data in a network comprising:
receiving data;
sending the data first on a first media using a first channel associated with the first media;
receiving the data at a first intelligent device connected to the first media;
resending the data on a second channel associated with the first media using the first intelligent device;
receiving the data at a second intelligent device connected to the first media; and
resending the data on a first channel associated with a second media connected to the second intelligent device.

10. The method of claim 9 further comprising encapsulating the data in a protocol-neutral wrapper.

11. The method of claim 9 further comprising a third media connected to the first and second intelligent devices.

12. The method of claim 9 wherein the first media is a comprised of powerlines in a building.

13. The method of claim 9 wherein the first media is a wireless media.

14. The method of claim 9 wherein the first media is a fiber optic media.

15. The method of claim 9 wherein the first media is a twisted pair media.

16. The method of claim 9 wherein each of the first and second intelligent devices has a private network address.

17. A network comprising:
a first media used to pass data on two or more channels;
a second media used to pass data on two or more channels; and
at least two intelligent devices connected to both the first media and the second media, each of the at least two intelligent devices including a transport layer operable to switch data between the first and second media and between the channels associated with the media.

18. The network of claim 17 further comprising a generic wrapper used to encapsulate the data for transmission on the first or second media.

19. The network of claim 17 wherein the first media is a guided media.

20. The network of claim 17 wherein the first media is an unguided media.

21. The network of claim 17 wherein the media is a wireless media.

22. A hopping mesh network for use in part with existing infrastructure in a building, the network comprising:
a first media comprised of power lines, the first media being used to pass packetized network data;
a second media disparate from the first media, the second media being used to pass packetized network data;
a first and a second intelligent device connected to both the first and second media, each of the first and second intelligent devices operable to encapsulate the packetized data in a generic wrapper used in the hopping mesh network, and the first and second intelligent devices further operable to pass the packetized data between the first and second media using the generic wrapper.

23. The hopping mesh network of claim 22 wherein each of the first and second media include two or more channels, each of the two or more channels capable of being used to pass the packetized network data.
